(19) United States
(12) Patent Application Publication
(10) Pub. No.: US 2006/0266161 A1
(43) Pub. Date: Nov. 30, 2006

(54) Modified wine bottle opener

(76) Inventor: Susan Anne Butler Mulcaire, Corona Del Mar, CA (US)

Correspondence Address: THE PATEL LAW FIRM, P.C., 2532 DUPONT DRIVE, IRVINE, CA, 92612, US

(21) Appl. No.: 11/441,720

(22) Filed: May 27, 2006

Related U.S. Application Data
(60) Provisional application No. 60/685,799, filed on May 31, 2005.

(51) Int. Cl. B67B 7/00

(52) U.S. Cl. 81/3.45

(57) ABSTRACT

The invention involves a specially designed cork-screw wine bottle opener. The wine bottle opener is uniquely designed to allow wine consumers to convey various messages commemorating the occasion during the ritual of opening the bottle of wine. In various exemplary embodiments, modified cork-screw wine bottle openers are disclosed.

### CROSS-REFERENCE TO RELATED APPLICATIONS

This utility patent application claims the benefit of the filing date of U.S provisional patent application Ser. No. 60/685,799 filed May 31, 2005, entitled Modified Wine Bottle Opener, the entire content of which provisional application is hereby incorporated herein in its entirety by this reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Wine bottle openers that are available on the market function only as tools to extract the cork out of a bottle of wine. Wine holds a unique and special stature in many societies. The opening of a bottle of wine is a custom that can be symbolic of friendships or celebrations of various events such as marriages, sporting events, or the coming of a new year.

The problem with cork-screw wine bottle openers is that they can be utilized only to extract the cork from the bottle and contribute little or nothing to the commemoration of special events. If a person wishes to convey a message further celebrating the ritual of opening a bottle of wine, he or she must either affix a greeting card to the bottle or express the message in some other way.

In these respects, the wine bottle opener according to the present invention departs from the conventional concepts and designs of the prior art, and in doing so, provides an apparatus for those who wish to commemorate a special occasion with a bottle of wine to further convey a celebratory message or gesture, simultaneous with the opening of the bottle, that can signify something about the consumer, the gathering or the occasion for which the bottle of wine is being opened.

### SUMMARY OF THE INVENTION

To address the shortcomings inherent in wing style (cork-screw) wine bottle openers now present in the prior art, the present invention provides a new type of cork-screw wine bottle opener. The new type of cork-screw wine bottle opener provides consumers not only with the means to remove cork from wine bottles, but also with the opportunity to express a message underscoring the significance of the bottle opening.

The present invention generally comprises of a wine bottle opener with cylinder molded to resemble a human torso, wings molded to resemble human arms, wing tips molded to resemble human hands, cap piece assembly molded to resemble a human head, and a spiral assembly mounted within the cylinder. In another embodiment, the invention comprises of a wine bottle opener wherein specific parts of human body are substituted with analogous animal or alien body parts.

One object of the present invention is to provide wine consumers with a tool to remove the cork from bottles of wine. Another object of the invention is to provide a means to communicate a message about or to commemorate a gathering or occasion. Another object of the invention is to provide a means of communicating a symbolic gesture that is of importance.

### BRIEF DESCRIPTION OF THE DRAWING

To the accomplishment of the above and related objects, this invention may be embodied in the form illustrated in the accompanying drawings, attention being called to the fact, however, that the drawings are illustrative only, and that changes may be made in the specific construction and method illustrated:

FIG. 1 illustrates a front elevational view of a prior art wine bottle opener;

FIG. 2 illustrates a rear elevational view of a prior art wine bottle opener;

FIG. 3 illustrates a front elevational view of a modified cork-screw wine bottle opener in a first embodiment;

FIG. 4 illustrates a front elevational view of a modified cork-screw wine bottle opener with message delivered in text form in a second embodiment;

FIG. 5 illustrates a front elevational view of a modified cork-screw wine bottle opener with message delivered in hand gesture form in a third embodiment;

FIG. 6 illustrates a front elevational view of a modified cork-screw wine bottle opener with message delivered in physical gesture form in a fourth embodiment;

FIG. 7 illustrates a front elevational view of a modified cork-screw wine bottle opener with message delivered in object form in a fifth embodiment; and

FIG. 8 illustrates a rear elevational view of a modified cork-screw wine bottle opener depicted in FIG. 7.

### DETAILED DESCRIPTION OF THE INVENTION

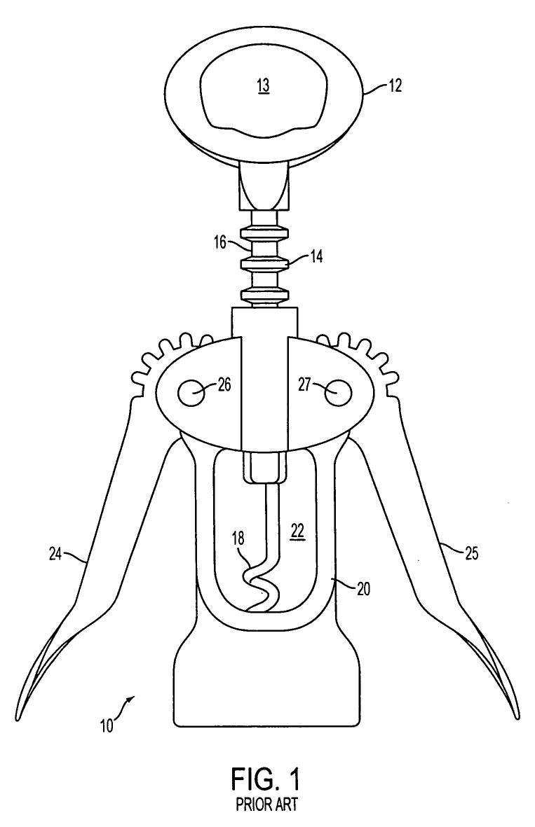

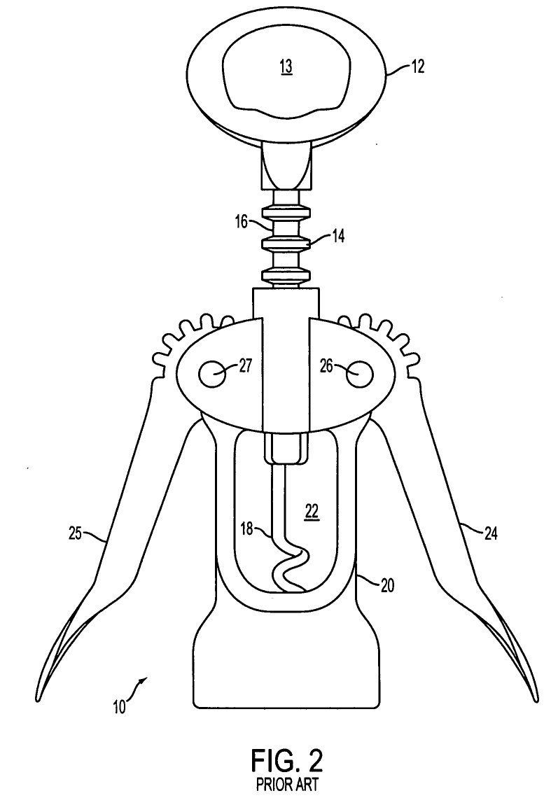

FIGS. 1 and 2 illustrate front and rear elevational views of a prior art cork-screw wine bottle opener 10, respectively. In one embodiment, cork-screw wine bottle opener 10 has a cap piece assembly 12 on top. In one embodiment, cap piece assembly 12 is fabricated by method of die-cast and is directly connected to a cork-screw 14. In one embodiment, cap piece assembly 12 is slightly oval in shape and has an opening 13 in the center that serves as a handle to grasp wine bottle opener 10. Opening 13 is proportionally smaller to fit within cap piece assembly 12. In one embodiment, cork-screw 14 is fabricated out of metal and contains a descending spiral groove 16. Descending spiral groove 16 allows a spiral assembly 18 to descend down a cylinder 20 when cap piece assembly 12 is manually twisted.

Cylinder 20 contains a rectangular vertical opening 22 through which spiral assembly 18 can be viewed. A wing 24 and a wing 25 are attached to opposing sides of cylinder 20 by way of a metallic screw 26 and a metallic screw 27, respectively. In one embodiment, wings 24 and 25 are elongated lengths of metal with arched tips at the ends. Wings 24 and 25 are pivotally connected to cylinder 20 with the aid of metallic screws 26 and 27. Metallic screws 26 and 27 allow wings 24 and 25 to rise as the cap piece assembly 12 is manually twisted and spiral assembly 18 descends down cylinder 20. In one embodiment, wings 24 and 25 are in a downward position at an approximate 30 degree angle to cylinder 20.

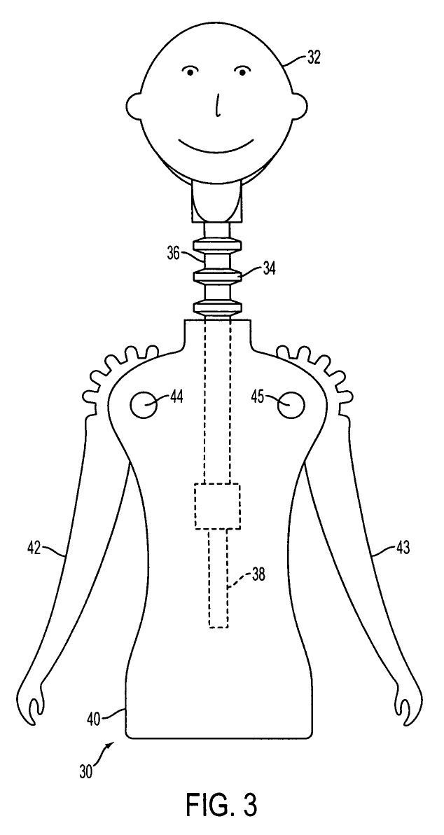

FIG. 3 illustrates a front elevational view of a modified cork-screw wine bottle opener 30 in a first embodiment. In one embodiment, cap piece assembly 32 of wine bottle opener 30 is solid and is shaped to resemble a human head. Alternatively, cap piece assembly 32 could be shaped to resemble other things, for example, an alien or animal head. In another embodiment, cap piece assembly 32 is flat with relief molding to resemble facial features. Cap piece assembly 32 could be fabricated by method of molding or by method of die-cast. Cap piece assembly 32 serves as a handle to grasp wine opener 30. Cap piece assembly 32 is connected to a corkscrew 34. In one embodiment, corkscrew 34 is fabricated out of metal and contains a descending spiral groove 36. Descending spiral groove 36 allows a spiral assembly 38, as detailed by the perforated outline, to descend down a cylinder 40 when cap piece assembly 32 is manually twisted.

In one embodiment, cylinder 40 is cylindrical in shape and contains no external openings on the surface of cylinder 40 through which spiral assembly 38 can be seen. Alternatively, cylinder 40 is cylindrical in shape, and is manufactured of transparent material to allow a viewer to see spiral assembly 38 ascending or descending through cylinder 40. Cylinder 40 of wine bottle opener 30 is shaped to resemble a human torso. In another embodiment, cylinder 40 could be shaped to resemble other things, for example, an alien or animal torso. A wing 42 and a wing 43 are attached to opposite sides of cylinder 40 by way of a metallic screw 44 and a metallic screw 45, respectively. In one embodiment, wings 42 and 43 are made to resemble human arms with the tips of wings 42 and 43 made in the shape of human hands. In another embodiment, wings 42 and 43 can be made to resemble other things, for example, alien or animal arms with the tips made in shape of claws. Wings 42 and 43 are pivotally connected to cylinder 40 with the aid of metallic screws 44 and 45. Metallic screws 44 and 45 allow wings 42 and 43 to rise as the cap piece assembly 32 is manually twisted and spiral assembly 38 descends down cylinder 40. As shown in FIG. 3, wings 42 and 43 are in a downward position at an approximate 30 degree angle to cylinder 40. Wings 42 and 43 could be fabricated out of metal and plastic. Other embodiments are possible and can be appropriately implemented depending on the physical form of an alien, an animal or a cartoon character.

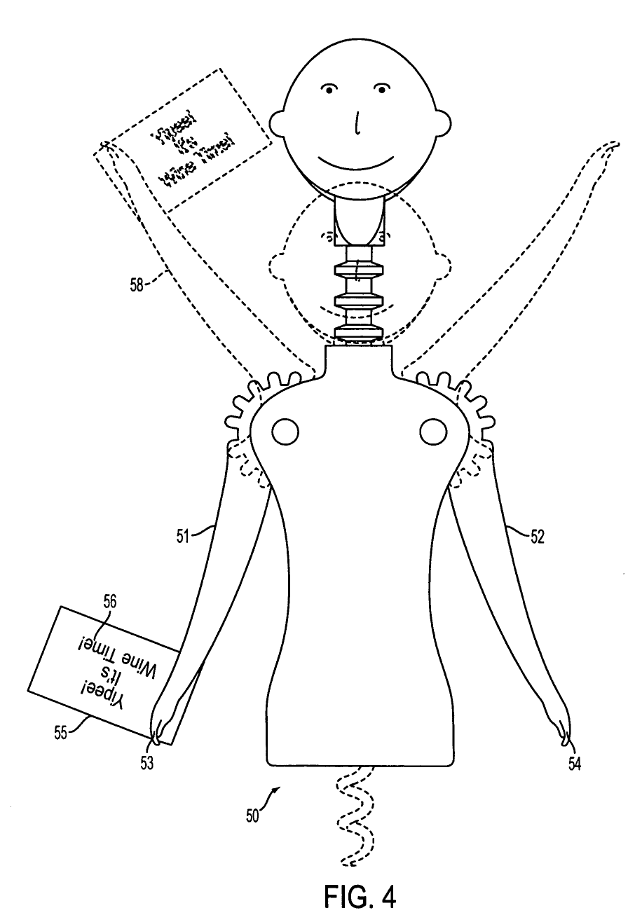

FIG. 4 illustrates a front elevational view of a modified cork-screw wine bottle opener 50 in a second embodiment. Wine bottle opener 50 is similar to wine bottle opener 30 (as shown in FIG. 3), in many respects, but has some additional modifications. In one embodiment, a wing 51 and a wing 52 have a wing tip 53 and a wing tip 54, respectively. Wing tip 53 is molded to include a die-cast protrusion 55. Protrusion 55 could be made out of plastic or other similar material. Protrusion 55 is approximately 0.75 inches by 0.75 inches. Protrusion 55 is affixed with a written communication message 56. In one embodiment, as shown in FIG. 4, written communication message 56 contains the message “Yippee! It's Wine Time!.”

As shown by solid lines, wings 51 and 52 are in a downward position. Furthermore, as shown by a perforated outline 58, wings 51 and 52 are in an upright position delivering written communication message 56.

The material suggested for manufacturing of wine bottle opener 50 and the dimensions of protrusion 55 as well as placement of protrusion 55 are exemplary only, and changes and modifications can be made therein which are within the full intended scope of the invention as herein described and claimed. In one embodiment, text or message or logo can be placed on wings of the wine bottle opener or at any other location that is most effective in conveying the message for the occasion. The text, message or logo may be placed vertically, horizontally or diagonally.

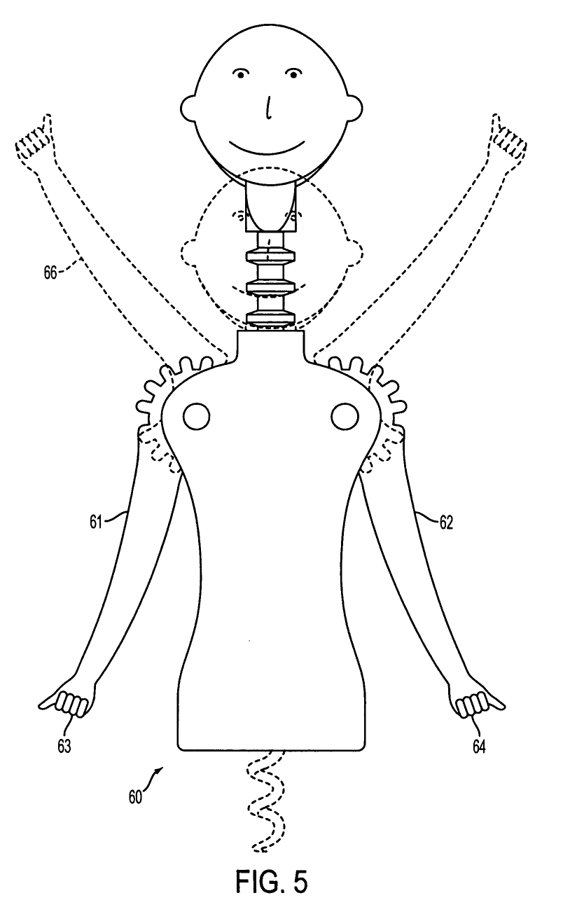

FIG. 5 illustrates a front elevational view of a modified cork-screw wine bottle opener 60 in a third embodiment. Wine bottle opener 60 is similar to the aforementioned modified wine bottle opener 30 (as shown in FIG. 3), but with some additional modifications. In one embodiment, a wing 61 and a wing 62 have a wing tip 63 and a wing tip 64, respectively. Wing tips 63 and 64 are molded to resemble hands giving the “Thumbs Up!” message.

As shown in FIG. 5, wings 61 and 62 are in a downward position. Additionally, as shown by a perforated outline 66 in FIG. 5, wings 61 and 62 are in an upright position delivering the “thumbs Up!” message.

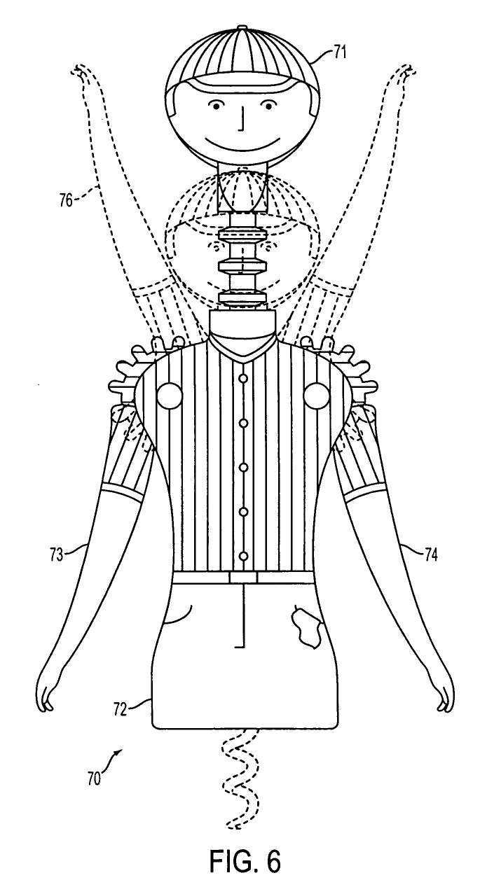

FIG. 6 illustrates a front elevational view of a modified cork-screw wine bottle opener 70 a fourth embodiment. Wine bottle opener 70 is similar to the aforementioned modified wine bottle opener 30 (as shown in FIG. 3), but with some additional modifications. In one embodiment, a cap piece assembly 71 is fabricated by utilizing a die-cast process and has been relief molded to resemble a sports referee's face and hat. In another embodiment, cap piece assembly 71 could be fabricated by another commercially known method with a material such as plastic or other durable material. Cylinder 72, along with a wing 73 and a wing 74, has been adorned with the traditional dress of a sports referee.

As shown in FIG. 6, wings 73 and 74 are in a downward position. Additionally, as shown by a perforated outline 76 in FIG. 6, wings 73 and 74 are in an upright position delivering the “Touchdown!” message.

In one embodiment, as shown in FIG. 6, cap piece assembly 71 further includes a commercially available chip that delivers an audible message. This audible sound, either musical or vocal, can convey a celebratory message or communicate something about the consumer or occasion for which the bottle of wine is being opened. Alternatively, the chip can be implanted into cylinder 72. The chip is activated by the rotation of the corkscrew 34 (shown in FIG. 3). Upon movement of corkscrew 34, the chip is triggered and the sound becomes audible. The modified wine bottle opener that includes commercially available chip may be distributed pre-programmed or can be re-programmed or programmed by a consumer based on simple instructions. Those having ordinary skill in the art will appreciate that various modifications can be made as to how a commercially available chip can be used or programmed without departing from the spirit of the invention.

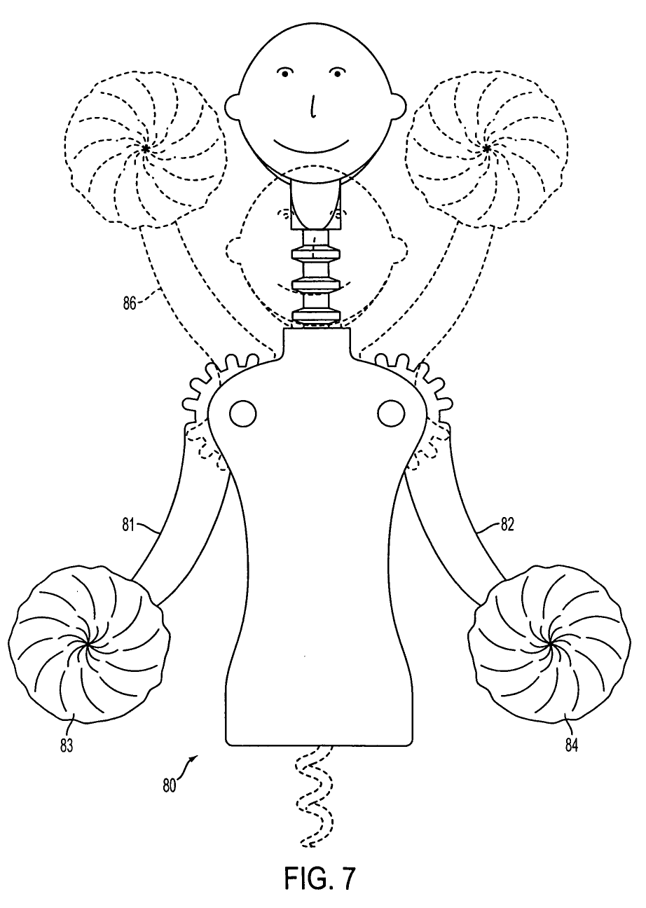

FIG. 7 illustrates a front elevational view of a modified cork-screw wine bottle opener 80 in a fifth embodiment. Wine bottle opener 80 is similar to the wine bottle opener 30 (as shown in FIG. 3) in many respects, but has some additional modifications. In one embodiment, a wing 81 and a wing 82 have a wing tip 83 and a wing tip 84, respectively. Wing tips 83 and 84 are fabricated by die-cast to resemble a cheerleader's pompoms. In another embodiment, wing tips 83 and 84 could be fabricated out of plastic or other durable material by utilizing a commercially known manufacturing method. Wing tips 83 and 84 could also be molded to resemble a baseball glove and bat.

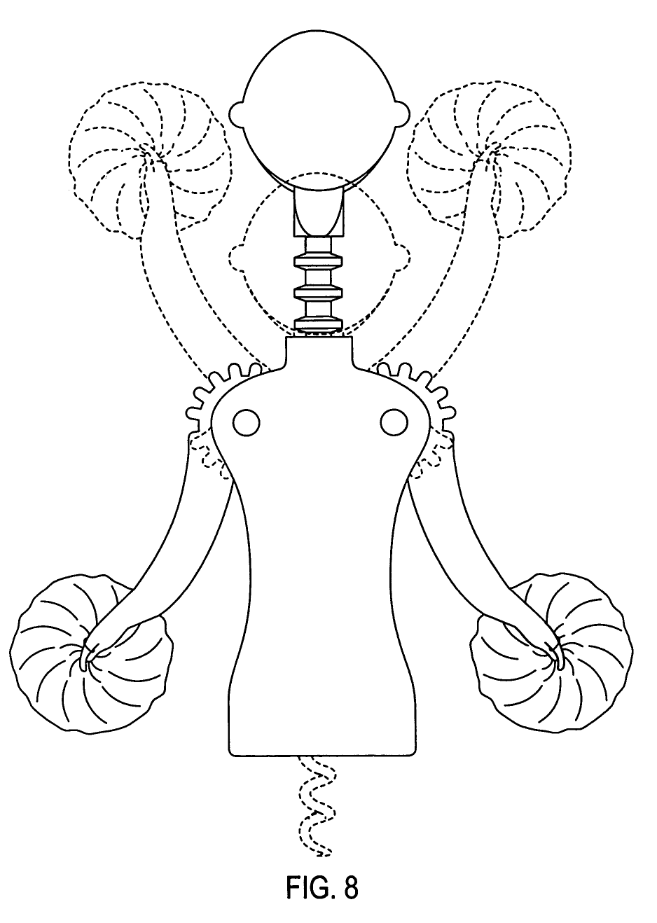

As shown in FIG. 7, wings 81 and 82 are in a downward position. Additionally, as shown by a perforated outline 86 in FIG. 7, wings 81 and 82 are in an upright position delivering the message by raising the cheerleader's pompoms. FIG. 8 illustrates a rear elevational view of modified cork-screw wine bottle opener 80 shown in FIG. 7.

The above description of modified wine bottle openers are exemplary and are not to be considered as limiting since simple changes may be made within the spirit of the modified bottle openers disclosed. Additionally, various embodiments disclosed are not limited to the embodiments illustrated in the figures. For example, other embodiments include wine bottle openers representing sports athletes, cartoon characters, famous theme-related figures, and may further include various messages and/or communications. While the invention has been described in terms of various specific embodiments, those skilled in the art will recognize that the invention can be practiced with modification within the spirit and scope of the claims. With such possibilities in mind, the invention is defined with reference to the following claims.

What is claimed is:

1. A modified cork-screw wine bottle opener comprising:
a cap piece assembly resembling a human head;
a cylindrical body resembling a human torso connected to the cap piece assembly;
a spiral assembly connected to the cap piece assembly and mounted within the cylindrical body;
a pair of wings resembling human limbs pivotally connected to the cylindrical body utilizing a pair of metallic screws; and
a pair of wing tips mounted on ends of the pair of wings resembling hands to deliver symbolic gestures or messages.

2. The modified cork-screw wine bottle opener of claim 1, further comprising a commercially available chip that communicates a written message to commemorate an event's meaning.

3. The modified cork-screw wine bottle opener of claim 1, further comprising a commercially available chip that communicates a symbolic gesture to commemorate an event's meaning.

4. The modified cork-screw wine bottle opener of claim 1, further comprising a commercially available chip implanted within the cylindrical body that delivers an audible message when activated by rotation of a corkscrew.

5. The modified cork-screw wine bottle opener described in claim 1, further comprising a commercially available chip implanted within the cap piece assembly that delivers an audible message when activated by rotation of a corkscrew.

6. A modified cork-screw wine bottle opener comprising a cork-screw wine opener that includes a means of communication to deliver a written message or a symbolic gesture to commemorate an event's meaning.

7. A modified cork-screw wine bottle opener comprising:
a cap piece assembly resembling an animal head;
a cylindrical body resembling an animal torso connected to the cap piece assembly;
a spiral assembly connected to the cap piece assembly and mounted within the cylindrical body;
a pair of wings resembling animal limbs pivotally connected to the cylindrical body utilizing a pair of metallic screws; and
a pair of wing tips mounted on ends of the pair of wings resembling animal paws to deliver symbolic gestures or messages.
